(19) United States
(12) Patent Application Publication
(10) Pub. No.: US 2021/0237241 A1
(43) Pub. Date: Aug. 5, 2021

(54) DRIVING TOOL

(71) Applicant: KOKI HOLDINGS CO., LTD., Tokyo (JP)

(72) Inventors: Kenta HARADA, Ibaraki (JP); Tomomasa NISHIKAWA, Ibaraki (JP); Tatsuya ITO, Ibaraki (JP)

(21) Appl. No.: 17/050,595

(22) PCT Filed: Mar. 29, 2019
(86) PCT No.: PCT/JP2019/014015

§ 371 Date: Oct. 26, 2020

(30) Foreign Application Priority Data
Apr. 26, 2018 (JP) 2018-085269

(51) Int. Cl. B25C 1/04; B25C 1/00

(52) U.S. Cl. CPC B25C 1/047; B25C 1/008

(57) ABSTRACT

A driving tool is capable of suppressing an increase in electric power consumed by an operation of a preventive mechanism. The driving tool includes a striking part, a housing, a pressure accumulator chamber, a pressure chamber, a route, an operating member, a contacting member, and a drive unit. The drive unit becomes an operating state when operating force is applied to an operating member and the contacting member contacts with a workpiece. The driving tool includes a solenoid and a control unit, the solenoid being started when electric power is supplied and preventing the drive unit becoming the operating state when a predetermined time with the contacting member not contacting with the workpiece lapses while the operating force is applied to the operating member, the control unit generating an output signal indicating that the predetermined time lapses. The control unit includes a timer circuit that requires no program.

### TECHNICAL FIELD

The present invention relates to a driving tool including: a pressure accumulator chamber to which a compressible gas is supplied from outside a housing; a pressure chamber to which the compressible gas is supplied from the pressure accumulator chamber; and a striking part which operates in a direction of striking a fastener by pressure of the pressure chamber.

### BACKGROUND ART

Known is a driving tool that operates a striking part to strike (hit) a fastener. A driving tool disclosed in Patent Document 1 includes a housing, a striking part, a spring, an electric motor, a battery, a drum, a wire rod, a clutch mechanism, a magazine, a nose, a trigger, a trigger switch, and a controller. The striking part is operable in a first direction by force of the spring. The wire rod is connected to the striking part, and the wire rod is wound around the drum. The magazine accommodates a fastener (s), and the fastener is sent to the nose. The controller is provided in the housing and is connected to the battery.

When the trigger is operated and the trigger switch is turned on, electric power is supplied from the battery to the electric motor and the electric motor rotates. When the drum is rotated by rotational force of the electric motor, the wire rod is wound around the drum. Then, the striking part operates toward a top dead center against the force of the spring. When the striking part reaches the top dead center, the clutch mechanism is released and the rotational force of the electric motor leads to no transmission to the wire rod. The striking part operates toward a bottom dead center by the force of the spring and strikes the fastener that has been sent to the nose. After a predetermined time has passed since the fastener is driven, the controller stops supplying the electric power from the battery to the electric motor.

### RELATED ART DOCUMENTS

### Patent Documents

Patent Document 1: Japanese Patent Application Laid-open No. 2009-208179

### SUMMARY OF THE INVENTION

### Problems to be Solved by the Invention

The inventors of the present application have considered providing a preventive mechanism, the preventive mechanism blocking the operation of the striking part in a driving tool that operates the striking part with the pressure of the compressible gas. The driving tool considered by the inventors of the present application is provided with no electric motor. Consequently, the inventors of the present application have recognized that if the preventive mechanism is operated by electric power, power consumption of the preventive mechanism may increase.

An object of the present invention is to provide a driving tool capable of suppressing an increase in electric power consumed for operating a preventive mechanism.

### Means for Solving the Problems

A driving tool according to one embodiment includes: a striking part provided so as to be operable and stoppable, the striking part operating by pressure of compressible gas to strike a fastener; a housing supporting the striking part; a pressure accumulator chamber provided in the housing and accommodating the compressible gas that is supplied from outside the housing; a pressure chamber operating the striking part in a direction of operating the fastener when the compressible gas is supplied from the pressure accumulator chamber; a route supplying the compressible gas in the pressure accumulator chamber to the pressure chamber; an operating member provided in the housing, operating force being applied to the operating member; a contacting member provided in the housing and contacting with a workpiece that drives the fastener; a drive unit having a standby state for shutting off the route and an operating state for opening the route, the drive unit becoming the operating state when the contacting member contacts with the workpiece while the operating force is applied to the operating member; a preventive mechanism provided so as to be started by supplying electric power, the preventive mechanism allowing the drive unit to bring: the operating state if an elapsed time when the contacting member is separated from the workpiece is within a predetermined time while the operating force is applied to the operating member; and the standby state if the elapsed time exceeds the predetermined time; and a control unit provided so as to generate an output signal indicating that the elapsed time exceeds the predetermined time, the control unit including a circuit configured by an active element and a passive element that require no program.

### Effects of the Invention

According to the driving tool of one embodiment, it can suppress the increase in the electric power consumed for operating the preventive mechanism.

### BRIEF DESCRIPTIONS OF THE DRAWINGS

FIG. 1 is a longitudinal sectional view showing a first embodiment of a driving tool;

FIG. 2 is a schematic diagram showing an example of a preventive mechanism provided in the driving tool of FIG. 1;

FIG. 3 is a partial sectional view showing an inside of a head cover of the driving tool of FIG. 1;

FIG. 4 is a partial sectional view of a state in which a striking part is at a bottom dead center in the driving tool of FIG. 1;

FIG. 5 is a partial sectional view showing a state of a trigger where a second mode is selected in the driving tool of FIG. 1;

FIG. 6 is a partial sectional view showing a state of the trigger where a first mode is selected in the driving tool of FIG. 1;

FIG. 7 is a bottom sectional view of a state in which a mode selection member provided in the driving tool of FIG. 1 is at a second operation position;

FIG. 8 is a bottom sectional view of a state in which the mode selection member provided in the driving tool of FIG. 1 is at a first operation position;

FIG. 9 is a schematic diagram of a state in which the second mode is selected and the preventive mechanism prevents an operation of the mode selection member;

FIG. 10 is a block diagram showing an outline of a control unit provided in the driving tool of FIG. 1;

FIG. 11 is a flowchart showing a control example performed by the driving tool of FIG. 1;

FIG. 12 is a circuit diagram showing a specific example of a control system illustrated in FIG. 10;

FIG. 13 is an example of a time chart where a trigger switch is turned off within a predetermined time from a point of time when the trigger switch is turned on;

FIG. 14 is an example of a time chart showing a state in which a predetermined time has passed from the point in time when the trigger switch is turned on;

FIG. 15 is a circuit diagram showing another specific example of the control unit provided in the driving tool;

FIG. 16 is a circuit diagram showing still another specific example of the control unit provided in the driving tool;

FIG. 17 is sectional view showing another example of the preventive mechanism provided in the driving tool;

FIG. 18 is a block diagram showing another outline of the control unit provided in the driving tool of FIG. 1;

FIG. 19 is a block diagram showing still another outline of the control unit provided in the driving tool of FIG. 1; and

FIG. 20 is a view showing another specific example of a timer circuit which the control unit has.

### DETAILED DESCRIPTION OF PREFERRED EMBODIMENTS

Next, typical embodiments among some embodiments included in a driving tool of the present invention will be described with reference to the drawings.

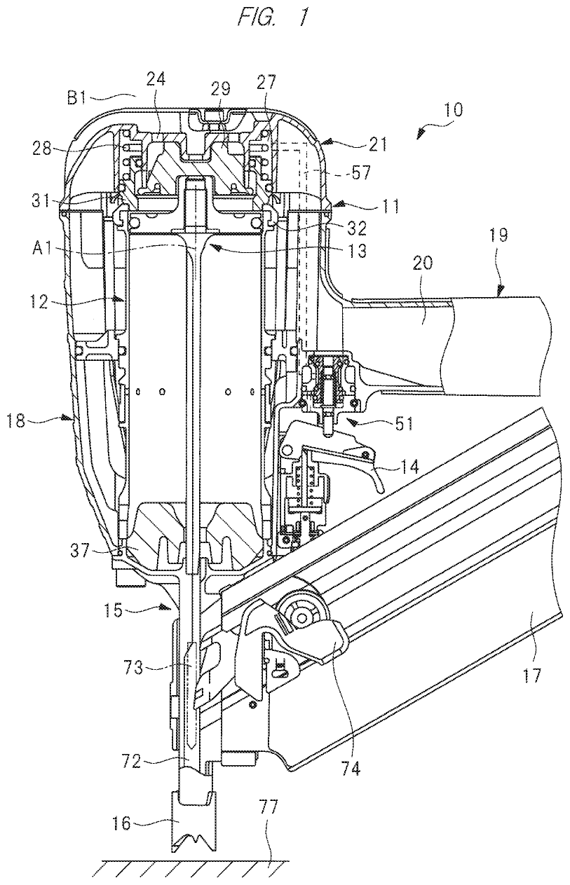

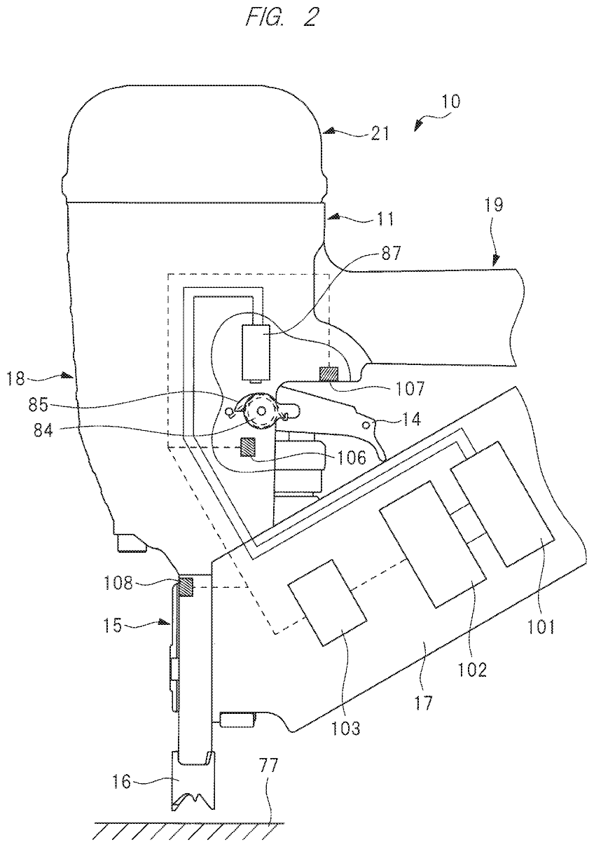

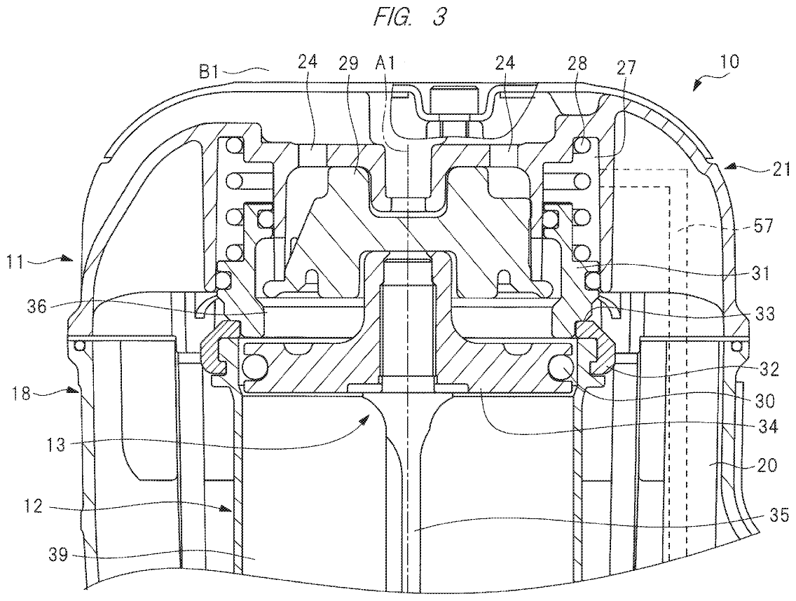

(First Embodiment) A first embodiment of a driving tool will be described with reference to FIGS. 1 and 2. A driving tool 10 includes a housing 11, a cylinder 12, a striking part 13, a trigger 14, an injection part 15, and a push lever 16. Further, a magazine 17 is attached to the driving tool 10. The housing 11 has a cylindrically shaped body part 18, a head cover 21 fixed to the body part 18, and a handle 19 connected to the body part 18.

As shown in FIG. 3, a pressure accumulator chamber 20 is formed over an inside of the handle 19, an inside of the body part 18, and an inside of the head cover 21. An air hose is connected to the handle 19. Compressed air as a compressible gas is supplied from an outside B1 of the housing 11 to the pressure accumulator chamber 20 via the air hose. The cylinder 12 is provided in the body part 18. The head cover 21 has an exhaust passage 24. The exhaust passage 24 links with the outside B1 of the housing 11.

A head valve 31 is provided in the head cover 21. The head valve 31 is movable in a direction of a center line A1 of the cylinder 12. A control chamber 27 is formed in the head cover 21. A biasing (energizing) member 28 is provided in the control chamber 27. The biasing member 28 is, as an example, a metal compression coil spring. The biasing member 28 biases the head valve 31 in a direction closer to the cylinder 12 and in the center line A1 direction. A fastener 29 is provided in the head cover 21. The fastener 29 is made of synthetic rubber as an example.

The cylinder 12 is positioned and fixed in the center line A1 direction with respect to the body part 18. A valve seat 32 is attached to an end of the cylinder 12 lying at the closest position to the head valve 31 in the center line A1 direction. The valve seat 32 is annular and is made of synthetic rubber. A port 33 is formed between the head valve 31 and the valve seat 32. When the head valve 31 is pressed against the valve seat 32, the head valve 31 closes the port 33. When the head valve 31 separates from the valve seat 32, the head valve 31 opens the port 33.

The striking part 13 has a piston 34 and a driver blade 35 fixed to the piston 34. The piston 34 is arranged in the cylinder 12. The striking part 13 is operable and stoppable in the center line A1 direction. A seal member 30 is attached to an outer peripheral surface of the piston 34. A piston upper chamber 36 is formed between the fastener 29 and the piston 34. When the head valve 31 opens the port 33, the pressure accumulator chamber 20 is connected to the piston upper chamber 36. When the head valve 31 closes the port 33, the pressure accumulator chamber 20 is shut off from the piston upper chamber 36.

The injection part 15 is fixed to an end opposite to a location, at which the head cover 21 is provided in the center line A1 direction, with respect to the body part 18.

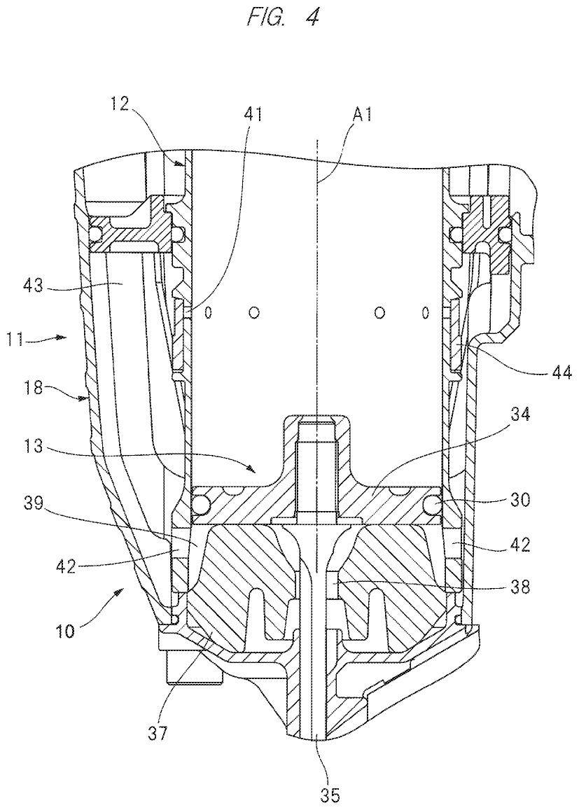

As shown in FIG. 4, a bumper 37 is provided in the cylinder 12. The bumper 37 is arranged in the cylinder 12 and at the closest position to the injection part 15 in the center line A1 direction. The bumper 37 is made of synthetic rubber or silicon rubber. The bumper 37 has a shaft hole 38, and the driver blade 35 is operable in the shaft hole 38 in the center line A1 direction. In the cylinder 12, a piston lower chamber 39 is formed between the piston 34 and the bumper 37. The seal member 30 airtightly shuts off the piston lower chamber 39 and the piston upper chamber 36.

Passages 41, 42 that radially penetrate the cylinder 12 are provided. A return air chamber 43 is formed between an outer surface of the cylinder 12 and the body part 18. The passage 41 links the piston lower chamber 39 and the return air chamber 43. A check valve 44 is provided in the cylinder 12. Compressed air is sealed in and over the piston lower chamber 39 and the return air chamber 43.

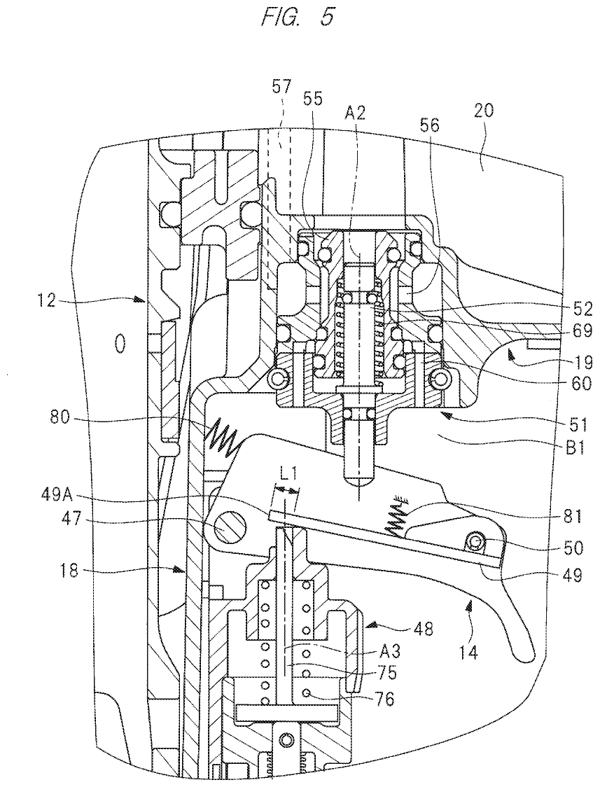

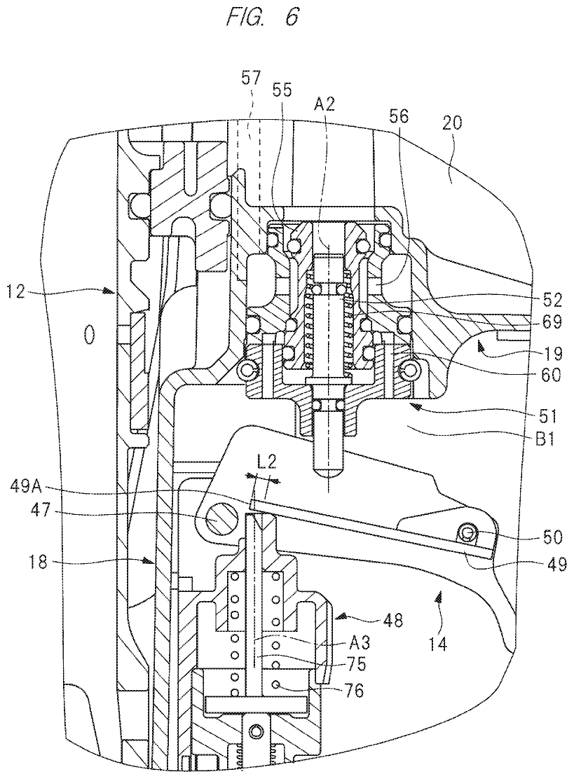

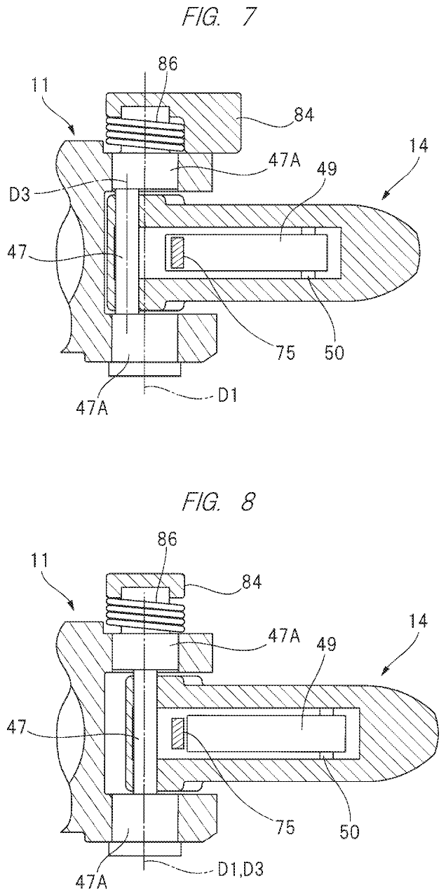

As shown in FIGS. 5 and 6, the trigger 14 is attached to the housing 11. The trigger 14 is attached to the housing 11 via a support shaft 47. A boss part 47A is provided at each end portion of the support shaft 47 in a longitudinal direction. As shown in FIGS. 7 and 8, the two boss parts 47A have cylindrical shapes, and the two boss parts 47A are each rotatable within a predetermined angle with respect to the housing 11 about a center line D1. The support shaft 47 is provided about a center line D3 eccentric from the center line D1.

A mode selection member 84 is fixed to one boss part 47A. The mode selection member 84 is an element for selecting a driving mode that is operated by the operator and is performed by the driving tool 10. The mode selection member 84 is, as an example, a lever or a knob. The driving mode includes a first mode and a second mode. The first mode can be defined as a single shot, and the second mode can be defined as a continuous shot.

When the operator operates the mode selection member 84, the two boss parts 47A is rotatable about the center line D1. When the two boss parts 47A operate about the center line D1, the support shaft 47 revolves around the center line D1. The trigger 14 can rotate about a center line D3 and revolve about the center line D1.

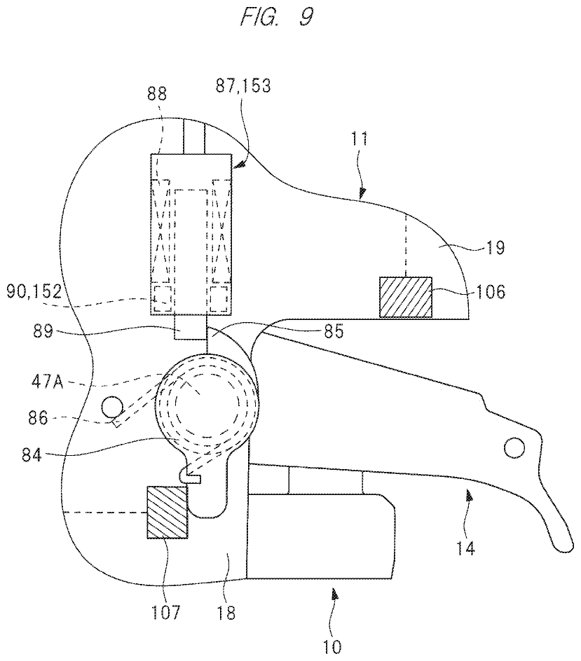

The operator grasps the handle 19 with his/her hand and applies or releases operating force to or from the trigger 14 with his/her finger(s). The operator selects the first mode when the striking part 13 is operated in the procedure of applying the operating force to the trigger 14 while the push lever 16 is pressed against a workpiece 77. The operator selects the second mode when the striking part 13 is operated in the procedure of pressing the push lever 16 against the workpiece 77 while the operating force is applied to the trigger 14. The mode selection member 84 has a first operation position shown in FIGS. 2 and 7 and corresponding to the first mode, and a second operation position shown in FIGS. 8 and 9 and corresponding to the second mode.

As shown in FIG. 9, the mode selection member 84 is provided with an engaging part 85. Further, a biasing member 86 for biasing the mode selection member 84 is provided. The biasing member 86 biases the mode selection member 84 clockwise in FIGS. 2 and 9. The biasing member 86 is, as an example, a metal spring.

The trigger 14 is operable within a range of a predetermined angle about the support shaft 47. As shown in FIGS. 5 and 6, a biasing member 80 for biasing the trigger 14 is provided. The biasing member 80 biases the trigger 14 clockwise about the support shaft 47. The biasing member 80 is, as an example, a metal spring. A cylindrical holder 48 is attached to the housing 11. The trigger 14 biased by the biasing member 80 contacts with the holder 48 and stops at an initial position.

An arm 49 is attached to the trigger 14. The arm 49 is operable within a range of a predetermined angle with respect to the trigger 14 about a support shaft 50. The support shaft 50 is provided on the trigger 14, and the support shaft 50 is provided at a position different from that of the support shaft 47. A biasing member 81 that biases the arm 49 about the support shaft 50 is provided. The biasing member 81 biases the arm 49 counterclockwise. The biasing member 81 is, as an example, a metal spring. The arm 49 biased by the biasing member 81 contacts with the holder 48 and stops at an initial position.

A trigger valve 51 is provided at a connection portion between the body part 18 and the handle 19. The trigger valve 51 includes a plunger 52, a valve body 55, passages 56, 60, and a biasing member 69. The passage 56 is connected to the control chamber 27 via a passage 57. The biasing member 69 is, as an example, a compression spring, and the biasing member 69 biases the plunger 52 in a direction of approaching the arm 49 and in a center line A2 direction.

As shown in FIG. 1, the injection part 15 is made of metal or non-ferrous metal as an example. The injection part 15 has a cylinder part 70 and a flange 71 connected to an outer peripheral surface of the cylinder part 70. The flange 71 is fixed to the body part 18 by a fixing element. The cylinder part 70 has an injection path 72. The center line A1 is located in the injection path 72, and the driver blade 35 is movable in the injection path 72 in a center line A1 direction.

The magazine 17 is fixed to the injection part 15. The magazine 17 accommodates the fastener 73. The magazine 17 has a feeder 74, and the feeder 74 sends the fastener 73 in the magazine 17 to the injection path 72.

Provided is a transmission member 75 which is connected to the push lever 16 so as to be able to transmit power. The transmission member 75 is supported by the holder 48. When the transmission member 75 contacts with the arm 49, the operating force of the push lever 16 is transmitted to the arm 49. When the transmission member 75 is separated from the arm 49, the operating force of the push lever 16 is not transmitted to the arm 49. The transmission member 75 is biased by a biasing member 76 in a direction of separating from the arm 49. The biasing member 76 is, as an example, a metal spring.

Further, a solenoid 87 shown in FIG. 9 is provided in the housing 11. The solenoid 87 has a coil 88, a plunger 89, and a spring 90. The plunger 89 is made of a magnetic material such as iron or steel. The spring 90 is an element that biases the plunger 89 in an axial direction. The spring 90 is, as an example, a metal compression spring. When electric power is supplied to the solenoid 87, the plunger 89 operates axially against biasing force of the spring 90 and stops at an operating position. When the plunger 89 stops at the operating position, the plunger 89 is engageable with the engaging part 85. When supply of electric power to the solenoid 87 is stopped, the plunger 89 operates in the axial direction by the force of the spring 90 and the plunger 89 stops at an initial position. When the plunger 89 stops at the initial position, the plunger 89 is released (disengaged) from the engaging part 85.

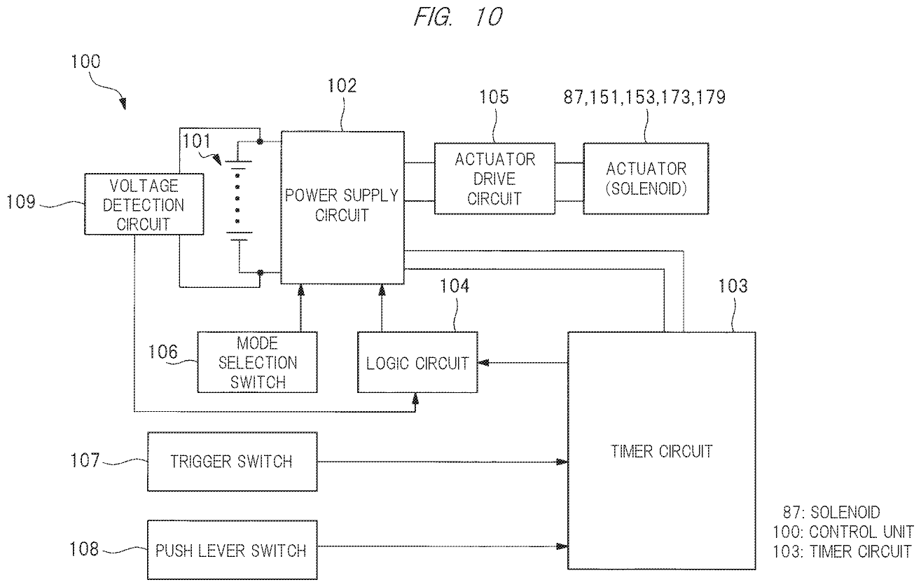

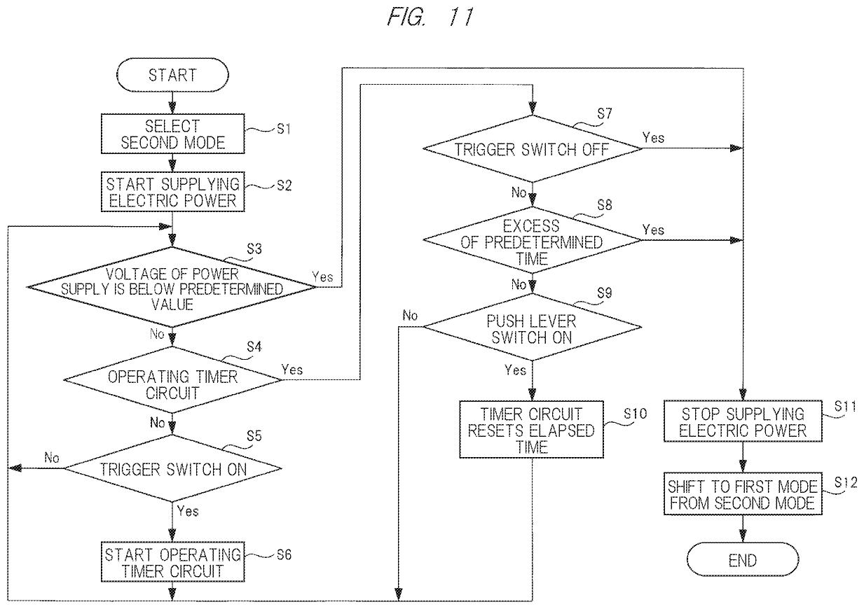

FIG. 10 is a block diagram showing an outline of a control unit 100 provided in the driving tool 10. The control unit 100 includes a power supply 101, a power supply circuit 102, a timer circuit 103, a logic circuit 104, an actuator drive circuit 105, a mode selection switch 106, a trigger switch 107, a push lever switch 108, and a voltage detection circuit 109. The power supply 101 supplies electric power to a control system, and may use a secondary battery capable of charging and discharging. The power supply 101 may be attached to, as an example, the magazine 17 shown in FIG. 2.

The trigger switch 107 turns on when the operating force is applied to the trigger 14, and turns off when the operating force with respect to the trigger 14 is released. The trigger switch 107 outputs a LOW signal when it turns off, and outputs a HIGH signal when it turns on. The push lever switch 108 turns on when the push lever 16 is pressed against the workpiece 77, and turns off when the push lever 16 separates from the workpiece 77. The mode selection switch 106 detects a mode, which the operator operates the mode selection member 84 to select, and generates an output signal. The mode selection switch 106 generates a LOW signal when the first mode is selected, and outputs a HIGH signal when the second mode is selected.

The output signal of the trigger switch 107 and the output signal of the push lever switch 108 are inputted to the timer circuit 103, respectively. The output signal of the mode selection switch 106 is inputted to the power supply circuit 102. The voltage detection circuit 109 detects voltage of the power supply 101, and the output signal of the voltage detection circuit 109 is inputted to the logic circuit 104. The timer circuit 103 measures an elapsed time from a point in time when the trigger switch 107 is turned on, and generates a predetermined output signal when the elapsed time exceeds a predetermined time. The output signal of the timer circuit 103 is inputted to the logic circuit 104. The logic circuit 104 generates an output signal based on the output signal of the timer circuit 103 and the output signal of the voltage detection circuit 109. The output signal of the logic circuit 104 is inputted to the power supply circuit 102. The power supply circuit 102 controls on and off of the power supply 101, and controls the supply and stop of electric power to the solenoid 87.

Next, an example in which the fastener 73 shown in FIG. 1 is driven into the workpiece 77 by using the driving tool 10 will be described. The user can operate the mode selection member 84 to select the first mode or the second mode. The support shaft 47 is eccentric with respect to the two boss parts 47A. Therefore, when the operating position of the mode selection member 84 changes, length from a contacting position of the transmission member 75 and the arm 49 to a tip 49A of the arm 49, that is, an effective length changes. An effective length L1 shown in FIG. 5 when the mode selection member 84 is stopped at a first operation position is greater than an effective length L2 shown in FIG. 6 when the mode selection member 84 is stopped at a second operation position.

(Example of selecting First Mode) When the operator selects the first mode, the electric power of the power supply 101 is not supplied to the solenoid 87. Consequently, the plunger 89 is stopped at the initial position by the force of the spring 90. Therefore, the plunger 89 is separated from the engaging part 85. Further, if at least one of the release of the operating force from the trigger 14 and the separate of the push lever 16 from the workpiece 77 is satisfied while the first mode is selected, the trigger valve 51, head valve 31, and striking part 13 of the driving tool 10 are in the following initial states.

First, since no operating force is applied from the arm 49 to the plunger 52, the trigger valve 51 is in the initial state. The trigger valve 51 in the initial state connects the pressure accumulator chamber 20 and the passage 56, and shuts off the passage 56 and the passage 60. Compressed air in the pressure accumulator chamber 20 is supplied to the control chamber 27, and the head valve 31 closes the port 33. Further, the piston upper chamber 36 couples with an outside B1 via the exhaust passage 24. Therefore, pressure in the piston upper chamber 36 is the same as atmospheric pressure. Consequently, the piston 34 is stopped in a state of being pressed against the fastener 29 by the pressure in the piston lower chamber 39. In this way, the striking part 13 stops at the top dead center.

Next, when the operator presses the push lever 16 against the workpiece 77, the operating force of the push lever 16 is transmitted to the transmission member 75. However, when the operating force to the trigger 14 is released, the trigger valve 51 is maintained in the initial state. Therefore, the striking part 13 stops at the top dead center.

When the operator applies the operating force to the trigger 14 while selecting the first mode and pushing the push lever 16 against the workpiece 77, the operating force of the arm 49 is transmitted to the plunger 52. Then, the trigger valve 51 leads to an operating state. The trigger valve 51 in the operating state shuts off the pressure accumulator chamber 20 and the passage 56, and connects the passage 56 and the passage 60. Consequently, the compressed air in the control chamber 27 is discharged to the outside B1 through the passage 57, passage 56, and passage 60, and the pressure in the control chamber 27 becomes the same as the atmospheric pressure.

When the pressure in the control chamber 27 becomes the same as the atmospheric pressure, the head valve 31 opens the port 33 and the pressure accumulator chamber 20 is connected to the piston upper chamber 36. Further, the head valve 31 shuts off the piston upper chamber 36 and the exhaust passage 24. Then, the compressed air in the pressure accumulator chamber 20 is supplied to the piston upper chamber 36; the striking part 13 operates in the center line A1 direction from the top dead center toward the bottom dead center; and the driver blade 35 strikes (hits) the fastener 73 in the injection path 72. The hit fastener 73 is driven into the workpiece 77.

After the striking part 13 drives the fastener 73 into the workpiece 77, the piston 34 collides with the bumper 37 and the bumper 37 absorbs a part of kinetic energy of the striking part 13. A position of the striking part 13 at a point in time when the piston 34 collides with the bumper 37 is the bottom dead center. Further, while the striking part 13 is operating from the top dead center toward the bottom dead center, the check valve 44 opens the passage 41 and the compressed air in the piston lower chamber 39 flows into the return air chamber 43 from the passage 41.

When the operator releases the push lever 16 from the workpiece 77, the arm 49 returns to the initial position from the operating position by the biasing force of the biasing member 81 and stops thereat. Consequently, the trigger valve 51 returns to the initial state, and the head valve 31 returns to the initial state and closes the port 33. Then, the piston 34 operates from the bottom dead center toward the top dead center. Further, the compressed air in the return air chamber 43 flows into the piston lower chamber 39 via the passage 42, and the striking part 13 returns to and stops at the top dead center.

Incidentally, when the operator separates the push lever 16 from the workpiece 77 while selecting the first mode and applying the operating force to the trigger 14, the tip 49A of the arm 40 stops out of an operating range of the transmission member 75. This is because the effective length L2 is smaller (shorter) than the effective length L1. Therefore, even if the push lever 16 is pressed against the workpiece 77 again, the operating force of the transmission member 75 is not transmitted to the arm 49.

(Example of selecting Second Mode) When the operator selects the second mode, the control unit 100 supplies the electric power of the power supply 101 to the solenoid 87. Then, the plunger 89 operates from the initial position against the force of the spring 90 and stops at the operating position. Further, the mode selection member 84 is biased counterclockwise. Consequently, the engaging part 85 is pressed against the plunger 89, and the mode selection member 84 stops at a second operating position.

Further, when the trigger switch 107 is turned off and the push lever switch 108 is turned off while the operator selects the second mode, the striking part 13 is stopped at the top dead center.

Next, when the operator applies the operating force to the trigger 14 and the push lever 16 is separated from the workpiece 77 while the second mode is selected, the operating force of the arm 49 is not transmitted to the plunger 52 and the trigger valve 51 is in the initial state.

When the push lever 16 is pressed against the workpiece 77 while the operator selects the second mode and the operating force is applied to the trigger 14, the push lever switch 108 is turned on. Further, the operating force of the push lever 16 is transmitted to the transmission member 75, and the arm 49 operates from the initial position to the operating position. Then, the trigger valve 51 becomes the operating state; the striking part 13 operates from the top dead center toward the bottom dead center; and the striking part 13 drives the fastener 73 into the workpiece 77.

When the operator separates the push lever 16 from the workpiece 77 after the striking part 13 drives the fastener 73 into the workpiece 77, the transmission member 75 returns to the initial position from the operating position and stops thereat. Further, the arm 49 returns to the initial position from the operating position and stops thereat, and the trigger valve 51 returns to the initial state from the operating state.

Subsequently, when the operator alternately repeats an operation of pressing the push lever 16 against the workpiece 77 and an operation of separating the push lever 16 from the workpiece 77 while selecting the second mode and applying the operating force to the trigger 14, the operating force of the transmission member 75 is transmitted to the plunger 52 via the arm 49 in pressing the push lever 16 against the workpiece 77 and the trigger valve 51 is changed to the operating state from the initial state. This is because the effective length L1 is larger (longer) than the effective length L2 and the arm 49 is located within the operating range of the transmission member 75.

Next, an example of the control performed by the driving tool 10 will be described with reference to the flowchart of FIG. 11. When the operator selects the second mode in step S1, the electric power of the power supply 101 is supplied to the control unit 100 and the electric power is supplied to the solenoid 87 in step S2. That is, the plunger 89 of the solenoid 87 moves from the initial position to the operating position, and the plunger 89 stops at the operating position. In other words, the support shaft 47 stops at the positions shown in FIGS. 5 and 7.

The control unit 100 determines in step S3 whether the voltage of the power supply 101 is less than a predetermined value. The predetermined value is a value capable of operating the plunger 89 of the solenoid 87 from the initial position to the operating position against the force of the spring 90. When the control unit 100 determines No in step S3, the control unit 100 determines in step S4 whether the timer circuit 103 is in operation.

When the control unit 100 determines No in step S4, the control unit 100 determines whether the trigger switch 107 is turned on in step S5. When the control unit 100 determines No in step S5, the control unit 100 proceeds to step S3. When the control unit 100 determines Yes in step S5, the control unit 100 starts the operation of the timer circuit 103 in step S6 and proceeds to step S3. The timer circuit 103 starting the operation means to start measuring an elapsed time from a point of time when the operating force is applied to the trigger 14.

When the control unit 100 determines Yes in step S4, it determines whether the trigger switch 107 has been turned off in step S7. When the control unit 100 determines No in step S7, the control unit 100 determines in step S8 whether the elapsed time has exceeded a predetermined time. The predetermined time is three seconds as an example. When the control unit 100 determines No in step S8, the control unit 100 determines in step S9 whether the push lever switch 108 has been turned on.

When the control unit 100 determines No in step S9, it proceeds to step S3. The determination of YES by the control unit 100 in step S9 means that the striking part 13 operates from the top dead center toward the bottom dead center. Therefore, when the control unit 100 determines Yes in step S9, the timer circuit 103 resets the measured elapsed time in step S10 and proceeds to step S3.

When the control unit 100 determines Yes in step S8, the supply of the electric power to the control unit 100 is stopped and the supply of the electric power to the solenoid 87 is stopped in step S11. When the supply of the electric power to the solenoid 87 is stopped, the plunger 89 operates from the operating position to the initial position and the plunger 89 stops at the initial position. Consequently, in step S12, the mode selection member 84 operates counterclockwise in FIG. 9 by the force of the biasing member 86 and stops at the first operating position, and the control example of FIG. 11 ends. This processing of step S12 brings a shift to the first mode from the second mode.

In this way, when an elapsed time when the trigger switch 107 is turned on and the push lever switch 108 is turned off exceeds a predetermined time while the second mode is selected, the supply of the electric power to the solenoid 87 is stopped, which brings the shift to the first mode from the second mode. Consequently, when the push lever 16 contacts with an object other than the workpiece 77 while the operator applies the operating force to the trigger 14, the striking part 13 can be prevented operating toward the bottom dead center. Further, the shift to the second mode from the first mode makes it possible to perform a driving operation of the fastener 73 based on the first mode once the operating force to the trigger 14 is released.

Further, when the control unit 100 determines Yes in step S3 or step S7, ends the control example of FIG. 11 via steps S11 and S12.

Further, performing the processings of steps S11 and S12 makes it possible to suppress an increase in an amount of electric power consumed by the power source 101. Therefore, the power supply 101 can be made small in size and weight. The electric power of the power source 101 is not used to operate the striking part 13 from the bottom dead center toward the top dead center. Consequently, the power supply 101 only needs to have a voltage sufficient for starting the control unit 100 and the solenoid 87, and can be made as small as possible.

Further, the control unit 100 has a circuit that requires no program, in other words, a non-programmable time-out circuit 103. Therefore, the circuit can be configured at a lower cost than a cost required in using a microcomputer whose program is changeable from outside.

A pneumatic driving tool that operates a striking part by using a compressible gas supplied from outside has no power supply source. The inventors of the present application disclose a driving tool 10 equipped with an electrical time-out mechanism in the pneumatic driving tool as described above. In the driving tool 10, an increase in weight of a main body can be suppressed by downsizing the power supply 101, and the control unit 100 can be configured at a low cost. Therefore, serious damage to usability of the driving tool 100 can be suppressed, and an increase in manufacture costs can be suppressed.

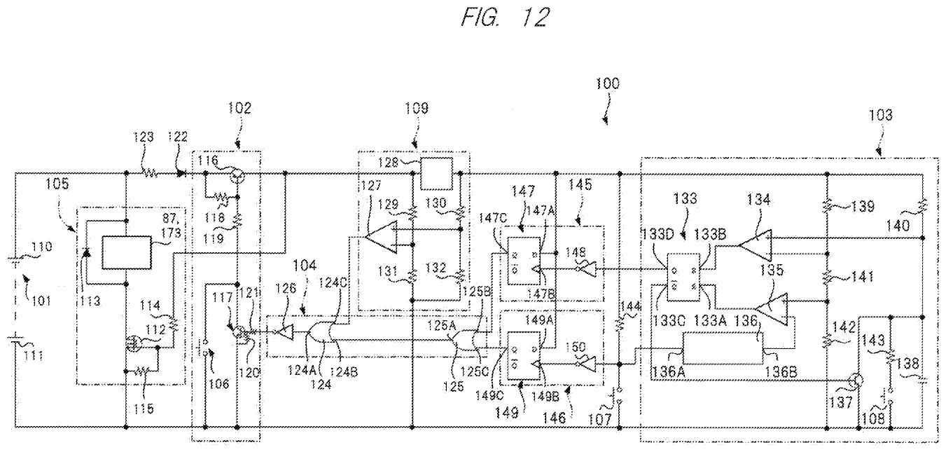

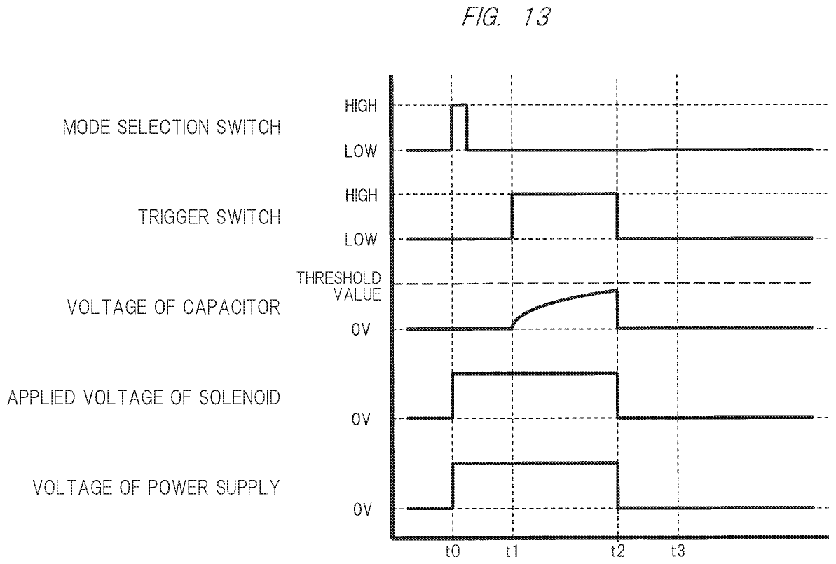

FIG. 12 is an example of elements constituting the control unit 100 shown in FIG. 10. The power supply 101 has a positive terminal 110 and a negative terminal 111. The actuator drive circuit 105 has a transistor 112, a diode 113 and resistors 114, 115. The transistor 112 is connected in series to the solenoid 87 and the negative terminal 111 of the power supply 101. The resistor 115 is connected between a base and an emitter of the transistor 112. The resistor 114 is connected to the base of the transistor 112. The solenoid 87 is connected in series to the positive terminal 110 and a collector of the transistor 112. The diode 113 is arranged in parallel to the solenoid 87.

The power supply circuit 102 has transistors 116, 117 and resistors 118, 119, 120, 121. The resistor 118 is connected between a base and an emitter of the transistor 116. The base of the transistor 116 is connected to a collector of the transistor 117 via the resistor 119. The emitter of the transistor 116 is connected to the resistor 114. An emitter of the transistor 117 is connected to the negative terminal 111 of the power supply 101. Further, the resistor 120 is connected between a base and the emitter of the transistor 117. Further, the resistor 121 is connected to the base of the transistor 117. The transistor 117 turns off the power supply 101 when a signal is inputted to the base.

Further, a first terminal of the mode selection switch 106 is connected to the collector of the transistor 117, and a second terminal of the mode selection switch 106 is connected to the negative terminal 111 of the power supply 101. Furthermore, a diode 122 and a resistor 123 are connected in series between the base of the transistor 116 and the positive terminal 110 of the power supply 101.

The logic circuit 104 includes OR gates 124, 125 and an inverter 126. The OR gate 124 has an output side 124A, a first input side 124B, and a second input side 124C. When a signal is inputted to either the first input side 124B or the second input side 124C, the OR gate 124 generates an output signal on the output side 124A. The OR gate 125 has an output side 125A, a first input side 125B, and a second input side 125C. When a signal is inputted to either the first input side 125B or the second input side 125C, the OR gate 125 generates an output signal on the output side 125A.

The output side 124A of the OR gate 124 is connected to the base of the transistor 117 via the inverter 126 and the resistor 121. The first input side 124B of the OR gate 124 is connected to the output side 125A of the OR gate 125.

The voltage detection circuit 109 includes a comparator 127, a DC/DC converter 128, and resistors 129, 130, 131, 132. The comparator 127 has a positive terminal, a negative terminal, and an output terminal. The comparator 127 compares a voltage inputted to the positive terminal with a voltage inputted to the negative terminal, and switches the signal outputted from the output terminal according to which of their voltages is larger.

An output side of the comparator 127 is connected to the second input side 124C of the OR gate 124. The resistor 129 is connected to a collector of the transistor 116 and the negative terminal of the comparator 127. The resistor 131 is connected to the negative terminal of the comparator 127 and the negative terminal 111 of the power supply 101. An input side of the DC/DC converter 128 is connected to the collector of the transistor 116, and an output side of the DC/DC converter 128 is connected to the positive terminal of the comparator 127 via the resistor 130. The resistor 132 is connected to the positive terminal of the comparator 127 and the negative terminal 111 of the power supply 101.

The timer circuit 103 includes an RS (reset set) type flip-flop 133, comparators 134, 135, a pulse generator 136, a transistor 137, a capacitor 138, and resistors 139, 140, 141, 142, 143. The resistor 139 is connected to a negative terminal of the comparator 134 and the output side of the DC/DC converter 128. The negative terminal of the comparator 134 is connected to a positive terminal of the comparator 135 via the resistor 141. A positive terminal of the comparator 134 is connected to the output side of the DC/DC converter 128 via the resistor 140. A negative terminal of the comparator 135 is connected to an output side 136B of the pulse generator 136.

The comparator 134 compares a voltage inputted to the positive terminal with a voltage inputted to the negative terminal, and switches a signal outputted from the output terminal according to which of their voltages is larger. The comparator 135 compares a voltage inputted to the positive terminal with a voltage inputted to the negative terminal, and switches a signal outputted from the output terminal according to which of their voltages is larger.

The first terminal of the trigger switch 107 is connected to the output side of the DC/DC converter 128 via the resistor 144. The first terminal of the trigger switch 107 is connected to an input side 136A of the pulse generator 136. The second terminal of the trigger switch 107 is connected to the negative terminal 111 of the power supply 101.

An input side of the capacitor 138 is connected to the output side of the DC/DC converter 128 via the resistor 140. An output side of the capacitor 138 is connected to the negative terminal 111 of the power supply 101. A first terminal of the push lever switch 108 is connected to the input side of the capacitor 138 via the resistor 143. A second terminal of the push lever switch 108 is connected to the negative terminal 111 of the power supply 101. A collector of the transistor 137 is connected to the input side of the capacitor 138, and an emitter of the transistor 137 is connected to the negative terminal 111 of the power supply 101.

The RS type flip-flop 133 has a first input side 133A, a second input side 133B, a first output side 133C, and a second output side 133D. When an input signal of the first input side 133A is switched, output signals of the first output side 133C and the second output side 133D are respectively switched. Further, when an input signal of the second input side 133B is switched, output signals of the first output side 133C and the second output side 133D are respectively switched. The first input side 133A is connected to the output side of the comparator 135. The second input side 133B is connected to an output side of the comparator 134. The first output side 133C is connected to the base of the transistor 137.

The control unit 100 further includes a time-out detection unit 145 and a trigger-off detection unit 146. The time-out detection unit 145 generates an output signal when an elapsed time exceeds a predetermined time, that is, when a time-out is detected. The time-out detection unit 145 includes a D-type flip-flop 147 and an inverter 148. The D-type flip-flop 147 has a first input side 147A, a second input side 147B, and an output side 147C.

The D-type flip-flop 147 switches an output signal of the output side 147C when an input signal of the first input side 147A is switched. Further, the D-type flip-flop 147 switches the output signal of the output side 147C when an input signal of the second input side 147B is switched. The first input side 147A is connected to the output side of the DC/DC converter 128. The second input side 147B is connected to the second output side 133D of the RS type flip-flop 133 via the inverter 148. The output side 147C is connected to the first input side 125B of the OR gate 125.

The trigger-off detection unit 146 generates an output signal when detecting that the trigger switch 107 is turned off. The trigger-off detection unit 146 includes a D-type flip-flop 149 and an inverter 150. The D-type flip-flop 149 has a first input side 149A, a second input side 149B, and an output side 149C. In the D-type flip-flop 149, when an input signal of the first input side 149A is switched, an output signal of the output side 149C is switched. Further, in the D-type flip-flop 149, when an input signal of the second input side 149B is switched, the output signal of the output side 149C is switched.

The first input side 149A is connected to the output side of the DC/DC converter 128. The second input side 149B is connected to the first terminal of the trigger switch 107 via the inverter 150. The output side 149C is connected to the second input side 125C of the OR gate 125.

The functions of the control unit 100 shown in FIG. 12 are as follows. If the mode selection switch 106 is turned off, the electric power of the power supply 101 is not supplied to the control unit 100 and the control unit 100 is stopped. If the second mode is selected in step S1 of FIG. 11 and the mode selection switch 106 is turned on, the electric power of the power supply 101 is supplied to the control unit 100. Specifically, a voltage is applied to the base of the transistor 112 in the actuator drive circuit 105, and the electric power is supplied to the solenoid 87. Consequently, the plunger 89 operates from the initial position to the operating position, and the plunger 89 stops at the operating position.

Further, the electric power of the power supply 101 is supplied to the timer circuit 103. If the second mode is selected and the trigger switch 107 is turned off, the transistor 137 is turned on and a current supplied to the timer circuit 103 passes through the transistor 137, so that no electric charge is accumulated in the capacitor 138.

If the second mode is selected and the trigger switch 107 is turned on, the output signal of the trigger switch 107 is inputted to the negative terminal of the comparator 135 via the pulse generator 136. Then, the output signal of the comparator 135 is inputted to the first input side 133A of the RS type flip-flop 133. The output signal of the first output side 133C in the RS type flip-flop 133 is inputted to the base of the transistor 137. Consequently, the transistor 137 is turned off, and the capacitor 138 of the timer circuit 103 accumulates electric charges. In this way, supplying the current to the capacitor 138 is a processing of step S6 in FIG. 11.

A signal corresponding to the voltage of the capacitor 138 is inputted to the positive terminal of the comparator 134. Further, a signal corresponding to the voltage of the positive terminal 110 of the power supply 101 is inputted to the negative terminal of the comparator 134. The comparator 134 compares the voltage of the positive terminal with the voltage of the negative terminal. If the voltage of the positive terminal of the comparator 134 is equal to or lower than the voltage of the negative terminal, the control unit 100 determines No in step S8 of FIG. 11. When the push lever switch 108 is turned on while No is determined in step S8 of FIG. 11, the control unit 100 determines Yes in step S9. Then, the electric charges of the capacitor 138 are discharged from the push lever switch 108. Discharging the electric charges of the capacitor 138 corresponds to a processing of step S10 in FIG. 11.

In contrast thereto, if the voltage of the positive terminal of the comparator 134 exceeds the voltage of the negative terminal, the comparator 134 outputs a signal from the output side. If the output signal of the comparator 134 is inputted to the second input side 133B of the RS type flip-flop 133, the signal is outputted from the second output side 133D of the RS type flip-flop 133. That is, the control unit 100 determines Yes in step S8 of FIG. 11.

If the signal outputted from the second output side 133D of the RS type flip-flop 133 is inputted to the second input side 147B of the D type flip-flop 147 via the inverter 148, the D type flip-flop 147 outputs the signal from the output side 147C. When a signal is inputted to either the first input side 125B or the second input side 125C, the OR gate 125 outputs the signal from the output side 125A. When a signal is inputted to either the first input side 124B or the second input side 124C, the OR gate 124 outputs the signal from the output side 124A.

If the signal outputted from the output side 124A is inputted to the base of the transistor 117, the transistors 116 and 117 are turned off and the power supply 101 is turned off. Consequently, the supply of the electric power to the solenoid 87 is stopped. That is, the control unit 100 performs a processing of step S11 in FIG. 11.

Further, when the voltage of the power supply 101 becomes less than a predetermined value, the control unit 100 of FIG. 12 outputs the signal from the output terminal of the comparator 127. If the signal is inputted to the second input side 124C of the OR gate 124, the power supply circuit 102 turns off the power supply 101. That is, the control unit 100 determines Yes in step S3 of FIG. 11 and performs the processing of step S11.

Incidentally, if the control unit 100 shown in FIG. 12 detects that the push lever switch 108 is turned on while the trigger switch 107 is turned off, it determines that the first mode has been selected, and does not perform the control example of FIG. 11. That is, the power supply 101 is turned off and the supply of the electric power to the solenoid 87 is stopped.

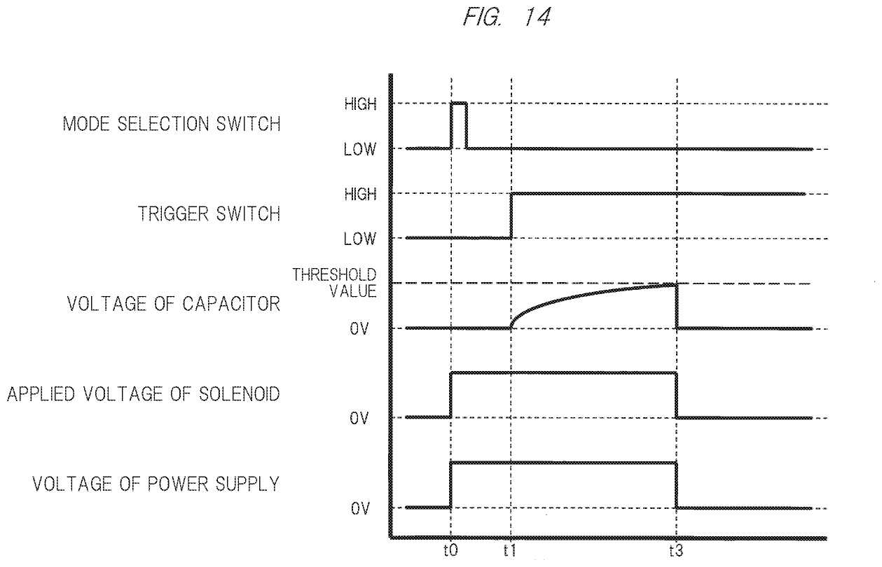

FIG. 13 is an example of a time chart corresponding to the control example of FIG. 11. Since the first mode is selected before a time t0, the signal of the mode selection switch is LOW. Further, the signal of the trigger switch is LOW; the voltage of the capacitor 138 is zero [V]; the voltage applied to the solenoid is zero [V]; and the voltage of the power supply is zero [V].

At the time t0, if the second mode is selected and the signal of the mode selection switch becomes HIGH, the voltage applied to the solenoid exceeds zero [V] and the voltage of the power supply exceeds zero [V]. At the time t0, the voltage of the capacitor 138 is zero [V] since the signal of the trigger switch is LOW.

The signal of the mode selection switch between the time t0 and time t1 is LOW. Incidentally, the mode is maintained in the second mode. At the time t1, if the signal of the trigger switch becomes HIGH, the voltage of the capacitor 138 rises from zero [V].

If the signal of the trigger switch becomes LOW at time t2 before the voltage of the capacitor exceeds a threshold value, the voltage of the capacitor drops to zero [V] and the voltage applied to the solenoid drops to zero [V]. The threshold value, which is the voltage of the capacitor, is used in step S8 of FIG. 11 to determine whether an elapsed time exceeds a predetermined time.

FIG. 14 is another example of the time chart corresponding to the control example of FIG. 11. In items of FIG. 14, the descriptions of the same items as those in FIG. 13 will be omitted. In FIG. 14, the signal of the trigger switch is LOW at time t3, and the voltage of the capacitor exceeds the threshold value. Consequently, it is determined to be Yes in step S8 of FIG. 11; its processing proceeds to step S11; the voltage of the power supply drops to zero [V]; and the voltage applied to the solenoid drops to zero [V].

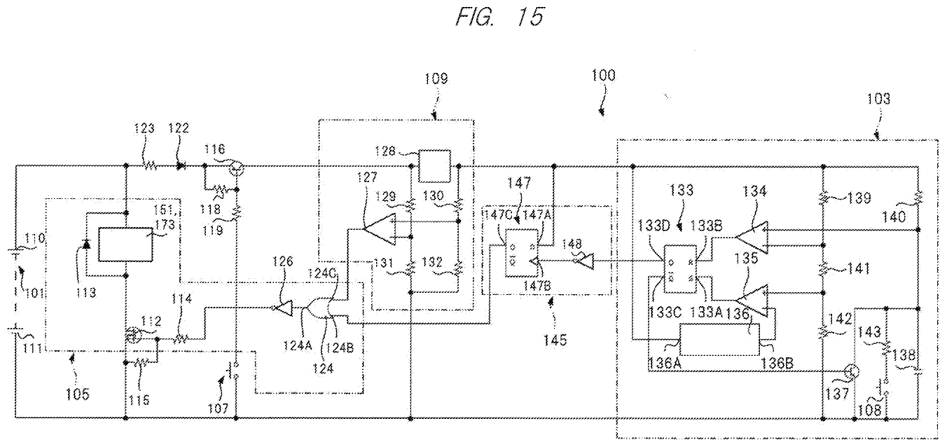

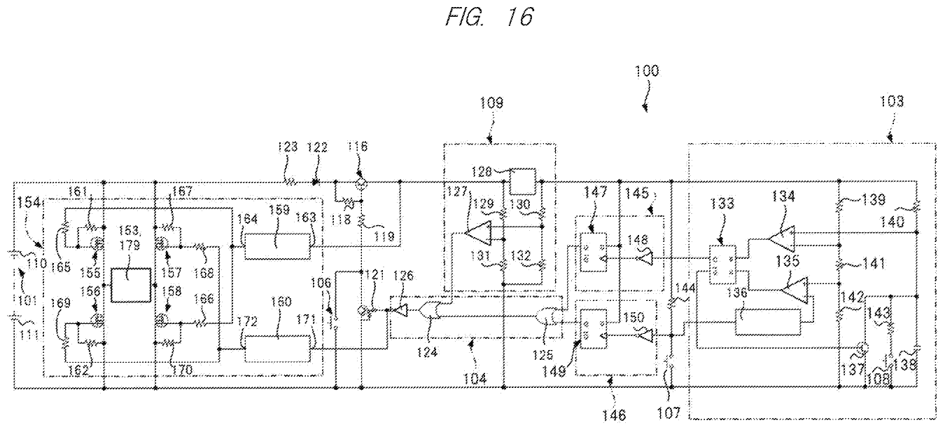

(Other Examples of Control Unit) Another example of the control unit 100 provided in the driving tool 10 will be described with reference to FIG. 15. In elements of FIG. 15, the same elements as those of FIG. 12 are denoted by the same reference numerals as those of FIG. 12. The control unit 100 of FIG. 15 does not include the logic circuit 104, trigger-off detection unit 146, mode selection switch 106, transistor 117, resistors 120, 121, and OR gate 125 of FIG. 12.

Further, the solenoid 151 shown in FIG. 15 is connected to the boss parts 47A shown in FIGS. 7 and 8 via a rack and pinion mechanism. That is, the linear operating force of the plunger in the solenoid 151 is converted into rotational force of the boss part 47A. Further, the mode selection member 84 of FIGS. 2, 7 and 8 is not provided, and the biasing force of the biasing member 86 is applied to the boss parts 47A. Further, the engaging part 85 is provided on the boss part 47A.

When the supply of the electric power to the solenoid 151 is stopped, the boss parts 47A are biased by the biasing force of the biasing member 86 and the trigger 14 is stopped at the position shown in FIG. 8. In contrast thereto, when the electric power is supplied to the solenoid 151, the boss parts 47A rotate against the biasing force of the biasing member 86 and the trigger 14 stops at the position shown in FIG. 7.

In the control unit 100 of FIG. 15, the first terminal of the trigger switch 107 is connected to the base of the transistor 116 via the resistor 119, and the second terminal of the trigger switch 107 is connected to the negative terminal 111 of the power supply 101. The actuator drive circuit 105 includes the inverter 126, OR gate 124, diode 113, transistor 112, and resistor 114. The output side 147C of the D-type flip-flop 147 is connected to the first input side 124B of the OR gate 124. The inverter 126 is connected to the transistor 112 via the resistor 114.

The control unit 100 shown in FIG. 15 can execute the control example shown in FIG. 11. If the trigger switch 107 is turned on while the push lever switch 108 is turned off, the control unit 100 determines that the second mode has been selected in step S1 of FIG. 11. Further, in step S2, the electric power of the power supply 101 is supplied to the control unit 100, and the electric power is supplied to the solenoid 151. Furthermore, if the electric power is supplied to the control unit 100, a signal is outputted from the output side 136B of the pulse generator 136 and the signal is inputted to the negative terminal of the comparator 135. Consequently, the transistor 137 is turned off by almost the same principle as that of the timer circuit 103 of FIG. 12, and the electric charges are accumulated in the capacitor 138 in step S6 of FIG. 11. Incidentally, when the control unit 100 of FIG. 15 performs the control example of FIG. 11, it skips the determination in step S5.

Then, if the voltage of the positive terminal of the comparator 134 exceeds the voltage of the negative terminal of the comparator 134, the control unit 100 determines Yes in step S8 of FIG. 11. Further, similarly to a control system of FIG. 12, a signal is outputted from the output side 147C of the D-type flip-flop 147, and the signal is inputted to the first input side 124B of the OR gate 124. Then, the actuator drive circuit 105 stops the supply of the electric power to the solenoid 151 in step S11.

When the control unit 100 of FIG. 15 determines Yes in step S8 and proceeds to step S11, the supply of the electric power to the control unit 100 is continued. In contrast thereto, the control unit 100 of FIG. 15 turns off the power supply 101 when determining Yes in step S3 or when determining Yes in step S7 and proceeding to step S11.

The control unit 100 of FIG. 15 can also control the supply and stop of the electric power to the solenoid 151. Therefore, the power consumption of the power supply 101 can be reduced. Further, the driving tool 10 does not need to provide the mode selection member 84 and the mode selection switch 106, which makes it possible to reduce the number of parts of the driving tool 10.

Incidentally, if the control unit 100 shown in FIG. 15 detects that the push lever switch 108 is turned on while the trigger switch 107 is turned off, it determines that the first mode has been selected, and does not perform the control example of FIG. 11. That is, the power supply 101 is turned off, and the supply of the electric power to the solenoid 151 is stopped.

(Another Examples of Solenoid) Another example of the solenoid will be described. A solenoid 153 shown in FIG. 9 is a keep solenoid having the coil 88, the plunger 89, and a ring-shaped permanent magnet 152. The solenoid 153 does not include the spring 90. If a direction of a current to the solenoid 153 is switched, a direction in which the plunger 89 operates is switched. Then, if the supply of the electric power to the solenoid 153 is stopped, the plunger 89 is stopped by attractive force of the permanent magnet 152. Consequently, when the supply of the electric power to the solenoid 153 is stopped, the plunger 89 is stopped by the attractive force of the permanent magnet 152 at either the initial position or the operating position.

If the solenoid 153 is used, the supply of the electric power to the solenoid 153 can be stopped at at least a part of time in a time interval between a point of time when measurement of an elapsed time is started and a point of time when a predetermined time lapses (elapses) therefrom. Therefore, the power consumption of the power supply 101 can be further reduced.

(Yet Another Example of Control Unit) Yet another example of the control unit 100 provided in the driving tool 10 of FIG. 1 will be described with reference to FIG. 16. The control unit 100 shown in FIG. 16 controls the solenoid 153. In the control unit 100 shown in FIG. 16, the same elements as those of the control unit 100 in FIG. 12 are denoted by the same reference numerals as those in FIG. 12. An actuator drive circuit 154 shown in FIG. 16 includes transistors 155, 156, 157, 158, and pulse generators 159, 160. A collector of the transistor 155 is connected to the positive terminal 110 of the power supply 101, and a resistor 161 is provided between the collector and a base of the transistor 155.

An emitter of the transistor 155 is connected to a collector of the transistor 156. An emitter of the transistor 156 is connected to the negative terminal 111 of the power supply 101. A resistor 162 is provided between the emitter and a base of the transistor 156. An input side 163 of the pulse generator 159 is connected between the collector of the transistor 116 and the input side of the DC/DC converter 128. An output side 164 of the pulse generator 159 is connected to the base of the transistor 155 via a resistor 165. An output side 164 of the pulse generator 159 is connected to a base of the transistor 158 via a resistor 166.

An emitter of the transistor 157 is connected to the positive terminal 110 of the power supply 101. A resistor 167 is provided between the emitter and a base of the transistor 157. The base of the transistor 157 is connected to the base of the transistor 156 via resistors 168, 169. The emitter of the transistor 158 is connected to the negative terminal 111 of the power supply 101. A resistor 170 is provided between the emitter and the base of the transistor 158.

An input side 171 of the pulse generator 160 is connected between the inverter 126 and the resistor 121. An output side 172 of the pulse generator 160 is connected between the resistor 168 and the resistor 169. The solenoid 153 is connected between the emitter of the transistor 155 and the collector of the transistor 156 and between the emitter of the transistor 157 and a collector of the transistor 158, respectively. In this way, the positive terminal 110 of the power supply 101 is branched into the transistors 155, 156 and the transistors 157, 158, and is connected to the negative terminal 111 of the power supply 101 to forma closed circuit. That is, a bridge circuit is formed by the transistors 155, 156, 157, and 158.

In step S2 of FIG. 11, the control unit 100 of FIG. 16 supplies the electric power to the solenoid 153 to operate the plunger 89 of FIG. 9 from the initial position to the operating position, and stops the supply of the electric power to the solenoid 153. Further, in step S11 of FIG. 11, it supplies the electric power to the solenoid 153 to operate the plunger 89 of FIG. 9 from the operating position to the initial position, and stops the supply of the electric power to the solenoid 153. The driving tool 10 having the control unit 100 of FIG. 16 can obtain the same effect as that of the driving tool 10 having the control unit 100 of FIG. 12.

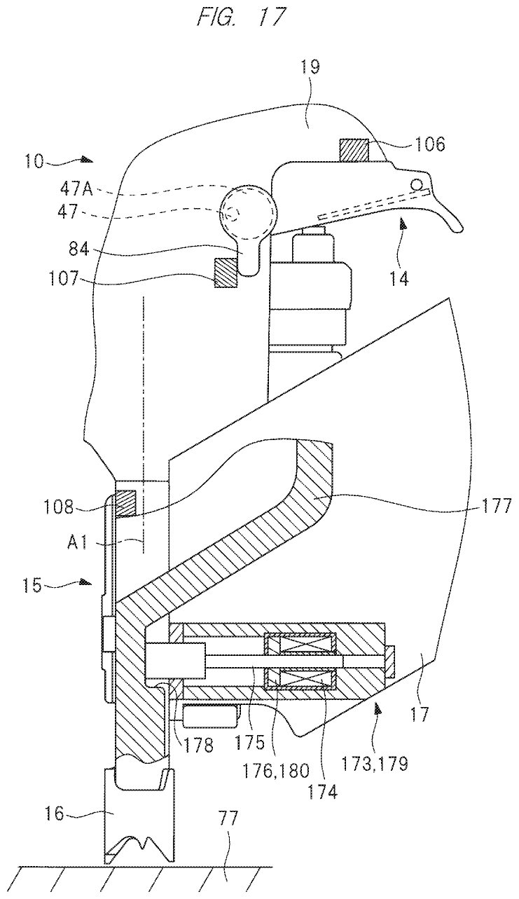

(Second Embodiment) A second embodiment of the driving tool will be described with reference to FIG. 17. In the second embodiment of the driving tool 10, the same configuration as that of the first embodiment of the driving tool 10 is denoted by the same reference numerals as those of the first embodiment of the driving tool 10. The trigger 14 can rotate around the support shaft 47 and can revolve around the boss part 47A. Further, the driving tool 10 shown in FIG. 17 does not include the biasing member 86 shown in FIGS. 7 and 8. Furthermore, the solenoid 87 of FIG. 9, which corresponds to the boss part 47A or the mode selection member 84, is not provided. In the driving tool 10 of FIG. 17, the mode selection member 84 can be switched at the first operation position and the second operation position only when the operator operates the mode selection member 84. Additionally, the driving tool 10 has the trigger valve 51 shown in FIGS. 5 and 6.

A solenoid 173 is provided in the injection part 15. The solenoid 173 includes a coil 174, a plunger 175 and a biasing member 176. The plunger 175 is operable in a direction intersecting the center line A1. The biasing member 176 biases the plunger 175 in a direction separate from the injection part 15. The biasing member 176 is, as an example, a metal spring. When the electric power is supplied to the solenoid 173, magnetic attractive force is generated. The plunger 175 is made of a magnetic material, for example, iron. If the supply of the electric power to the solenoid 173 is stopped, the plunger 175 is stopped at the initial position by the force of the biasing member 176. If the electric power is supplied to the solenoid 173, the plunger 175 operates against the force of the biasing member 176 and stops at the operating position.

Provided is an arm 177 that transmits the operating force of the push lever 16 to the transmission member 75. The arm 177 has an engaging part 178. The arm 177 is operable in the center line A1 direction together with the push lever 16.

The driving tool 10 of FIG. 17 may include the control unit 100 of FIG. 12. When the operator selects the first mode, the control unit 1000 stops the supply of the electric power to the solenoid 173. Then, the plunger 175 stops at the initial position by the force of the biasing member 176. When the plunger 175 stops at the initial position, a tip of the plunger 175 is at a position outside the operating range of the arm 177. Consequently, if the push lever 16 is pressed against the workpiece 77, the arm 177 operates in the center line A1 direction and the operating force of the arm 177 is transmitted to the plunger 52 via the transmission member 75.

Further, when the operator selects the second mode, the control unit 100 stops the supply of the electric power to the solenoid 173. Then, when the operator selects the second mode and if the elapsed time from a point of time when the trigger switch 107 is turned on is within a predetermined time, the supply to the electric power to the solenoid 173 is stopped. In contrast thereto, when the operator selects the second mode and if the elapsed time from the point of time when the trigger switch 107 is turned on exceeds the predetermined time with the push lever switch 108 not turned on, the electric power is supplied to the solenoid 173 and the plunger 175 stops at the operating position. When the plunger 175 stops at the operating position, the tip of the plunger 175 is within the operating range of the arm 177. Consequently, if the push lever 16 contacts with an object other than the workpiece 77 after the elapsed time exceeds the predetermined time, the tip of the plunger 175 is engaged with the engaging part 178, which brings restriction of the operation of the arm 177.

Incidentally, if the trigger switch 107 is turned off after the electric power is supplied to the solenoid 173, the control unit 100 stops the supply of the electric power to the solenoid 173 and resets the elapsed time.

The driving tool 10 of FIG. 17 may include the control unit 100 of FIG. 15. In this case, the mode selection member 84 and the mode selection switch 106 are not provided. When the push lever switch 108 is turned on while the trigger switch 107 is turned off, the control unit 100 of FIG. 15 determines that the first mode is selected, and stops the supply of the electric power to the solenoid 173. Further, when the trigger switch 107 is turned on while the push lever switch 108 is turned off, the control unit 100 of FIG. 15 determines that the second mode is selected, and performs the control example of FIG. 11. Furthermore, the control unit 100 of FIG. 15 stops the supply of the electric power to the solenoid 173 in step S11 of FIG. 11. Also in the driving tool 10 of FIG. 17, the power consumption of the power supply 101 can be suppressed.

Another example of the solenoid shown in FIG. 17 will be described. A solenoid 179 shown in FIG. 17 is a keep solenoid having the coil 174, the plunger 175, and a ring-shaped permanent magnet 180. The solenoid 179 does not include the biasing member 176. When the direction of the current to the coil 174 is switched, the direction in which the plunger 175 operates is switched. Then, if the supply of the electric power to the solenoid 179 is stopped, the plunger 175 is stopped by attractive force of the permanent magnet 180. Consequently, when the supply of the electric power to the solenoid 179 is stopped, the plunger 175 is stopped by the attractive force of the permanent magnet 180 at either the initial position or the operating position.

The driving tool 10 having the solenoid 179 has the control unit 100 of FIG. 16 and can perform the control example of FIG. 11. In step S2, the control unit 100 supplies the electric power to the solenoid 179, moves the plunger 175 to the operating position, and thereafter stops the supply of the electric power to the solenoid 179.

The control unit 100 of FIG. 16 supplies the electric power to the solenoid 179 in step S11 to operate the plunger 175 from the operating position to the initial position, and thereafter stops the supply of the electric power to the solenoid 179. The driving tool 10 of FIG. 17 having the control unit 100 of FIG. 16 can obtain the same effect as that of the driving tool 10 having the control unit 100 of FIG. 16.

If the solenoid 179 is used, the supply of the electric power to the solenoid 179 can be stopped at at least a part of time in a time interval between a point of time when the measurement of the elapsed time is started and a point of time when the predetermined time lapses. Therefore, the power consumption of the power supply 101 can be further reduced.

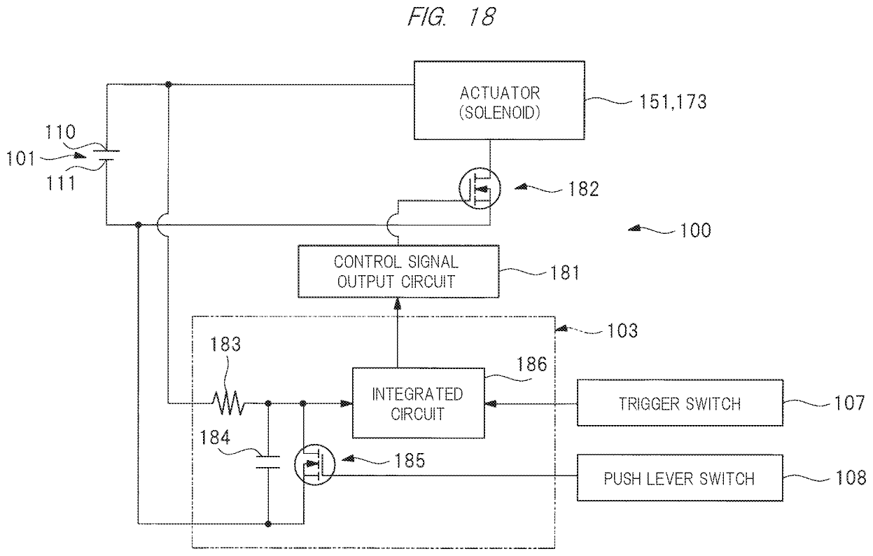

(Another Outline of Control Unit) FIG. 18 is a block diagram showing another outline of the control unit 100. The control unit 100 includes the timer circuit 103, a control signal output circuit 181, and a transistor 182. An emitter of the transistor 182 is connected to the negative terminal 111 of the power supply 101. A collector of the transistor 182 is connected to the solenoid 151. The solenoid 151 is connected to the positive terminal 110 of the power supply 101.

The timer circuit 103 includes a resistor 183, a capacitor 184, a transistor 185, and an integrated circuit 186. The positive terminal 110 of the power supply 101 is connected to the negative terminal 111 of the power supply 101 via the resistor 183 and the capacitor 184. An emitter of the transistor 185 is connected to the negative terminal 111 of the power supply 101. The collector of the transistor 182 is connected between the resistor 183 and the capacitor 184. Further, the collector of the transistor 182 is connected to the integrated circuit 186. A base of the transistor 185 is connected to the push lever switch 108. The trigger switch 107 is connected to the integrated circuit 186. The integrated circuit 186 is an analog circuit or a digital circuit that recognizes a voltage corresponding to a predetermined time in advance. An output side of the integrated circuit 186 is connected to an input side of the control signal output circuit 181. An output side of the control signal output circuit 181 is connected to the emitter of the transistor 182.

In the control unit 100 shown in FIG. 18, if the trigger switch 107 is turned on while the push lever switch 108 is turned off, a voltage is applied to the timer circuit 103 and the timer circuit 103 is started. Further, an output signal of the integrated circuit 186 is inputted to the control signal output circuit 181. The signal outputted from the control signal output circuit 181 is inputted to a base of the transistor 182. Then, the transistor 182 is turned on, and the electric power of the power supply 101 is supplied to the solenoid 151. Consequently, the support shaft 47 stops at the position shown in FIG. 5. Further, the current of the power supply 101 flows through the capacitor 184, and the capacitor 184 accumulates electric charges. That is, the timer circuit 103 starts measuring an elapsed time.

If the push lever switch 108 is turned on within a predetermined time from a point of time when the timer circuit 103 starts measuring the elapsed time, the transistor 185 is turned on and the current of the power supply 101 flows through the transistor 185. Further, the electric charges accumulated in the capacitor 184 are discharged via the transistor 185. That is, the timer circuit 103 resets the elapsed time.

If the predetermined time with the push lever switch 108 not turned on lapses from the point of time when the timer circuit 103 starts measuring the elapsed time, a signal outputted from the integrated circuit 186 is inputted to the control signal output circuit 181. Then, the output signal of the control signal output circuit 181 is inputted to the transistor 182, and the transistor 182 is turned off. Consequently, the supply of the electric power to the solenoid 151 is stopped, and the support shaft 47 is stopped at the position shown in FIG. 6. Incidentally, the solenoid 151 shown in FIG. 18 may be the solenoid 173 shown in FIG. 17. The control unit 100 shown in FIG. 18 can suppress an increase in the power consumption of the power supply 101. When the trigger switch 107 is turned off, the supply of the electric power to the timer circuit 103 is stopped.

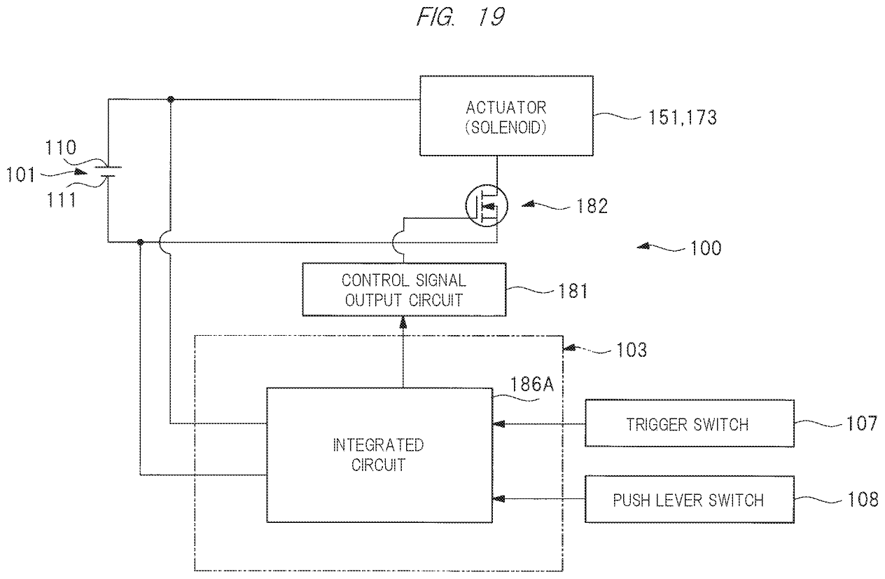

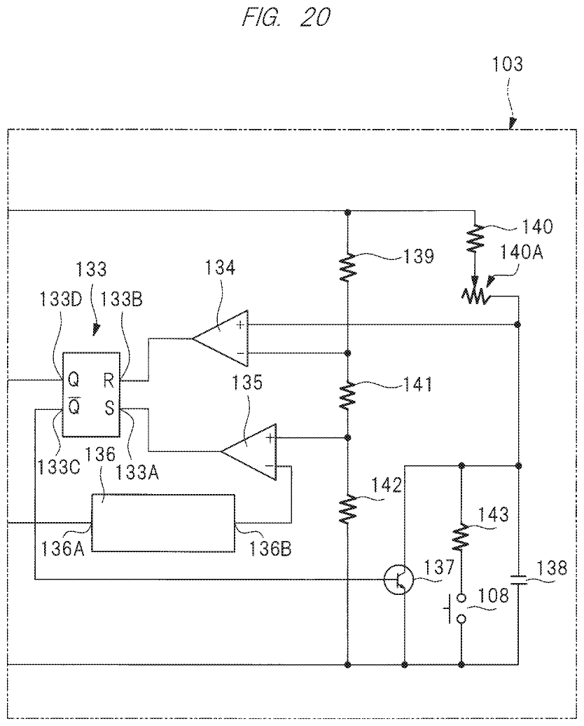

(Still Another Outline of Control Unit) FIG. 19 is a block diagram showing still another outline of the control unit 100. The timer circuit 103 has an integrated circuit 186A. The integrated circuit 186A is a digital circuit. If the trigger switch 107 is turned on, the electric power of the power supply 101 is supplied to the timer circuit 103 and the timer circuit 103 is started (activated). Further, an output signal of the integrated circuit 186A is inputted to the control signal output circuit 181.

If the predetermined time with the push lever switch 108 not turned on lapses from the point of time when the timer circuit 103 starts measuring the elapsed time, the signal outputted from the integrated circuit 186A is inputted to the control signal output circuit 181. Incidentally, the solenoid 151 shown in FIG. 19 may be the solenoid 173 shown in FIG. 17. The control unit 100 shown in FIG. 19 can suppress an increase in the power consumption of the power supply 101.

When the trigger switch 107 is turned off, the supply of the electric power to the timer circuit 103 is stopped. Other functions of the control unit 100 shown in FIG. 19 are the same as the other functions of the control unit 100 shown in FIG. 18.

FIG. 20 is a diagram showing another example of the timer circuit 103. The timer circuit 103 of FIG. 20 is provided with a variable resistor 140A in addition to the resistor 140 in the timer circuit 103 of FIGS. 12, 15, and 16. The resistor 140 and the variable resistor 140A are arranged in series. A resistance value of the variable resistor 140A can be changed. The variable resistor 140A has an adjusting lever as an example, and the resistance value can be changed by operating the adjusting lever. Incidentally, the adjusting lever is arranged inside the housing 11 and cannot be operated from outside the housing 11. In a process of assembling the timer circuit 103, the operator operates the adjusting lever to set a resistance value.

The predetermined time can be changed by adjusting the resistance value of the variable resistor 140A. When the resistance value of the variable resistor 140A is set to a predetermined value, the predetermined time is set to three seconds as an example. if the resistance value of the variable resistor 140A is set below the predetermined value, the predetermined time exceeds three seconds. If the resistance value of the variable resistor 140A is set at or above the predetermined value, the predetermined time becomes three seconds or less.

An example of the technical meanings of the matters described in the embodiments is as follows. The driving tool 10 is an example of a driving tool. The striking part 13 is an example of a striking part. The housing 11 is an example of a housing. The pressure accumulator chamber 20 is an example of a pressure accumulator chamber. The piston upper chamber 36 is an example of a pressure chamber. The port 33 is an example of a route. The trigger 14 is an example of an operating member. The push lever 16 is an example of a contacting member. The trigger valve 51, head valve 31, control chamber 27, support shaft 47, and trigger 14 are examples of a drive unit. The solenoids 87, 151, 153, 173, 179 each form part of a preventive mechanism.

The control unit 100 is an example of a control unit. The timer circuit 103 is an example of a circuit. The timer circuit 103 shown in FIGS. 12, 15 and 16 is an example of an analog circuit. The capacitor 138 is an example of a passive element and a capacitor, and the comparators 134, 135 are examples of an active element and a comparator. The power supply circuit 102 is an example of a power supply control unit. The mode selection member 84 is an example of a switching member. The solenoids 87, 151, 153, and 173 are examples of a mode changing mechanism. The head valve 31 is an example of a valve body. The control chamber 27 is an example of a control chamber. The fastener 73 is an example of a fastener. An initial state of the trigger valve 51 and a state in which the head valve 31 closes the port 33 are examples of a standby state. An operating state of the trigger valve 51 and a state in which the head valve 31 opens the port 33 are examples of an operating state. The voltage inputted to the negative terminal of the comparator 134 is an example of a predetermined voltage.

The driving tool is not limited to the above embodiments, and can be variously altered within a range of not departing from the gist thereof. For example, the operating member includes an element, to which operating force is applied to operate linearly within a predetermined range, in addition to an element to which the operating force is applied to rotate within a predetermined angle range. The operating member includes a lever, a knob, a button, and an arm, etc. The contacting member is an element that is pressed against the workpiece and operates linearly. The contacting member includes a lever, an arm, a rod, and a plunger, etc.

Further, when the second mode is selected and if the predetermined time with the push lever switch 108 not turned on lapses from the point of time when the trigger switch 107 is turned on, the solenoid prevents the striking part 13 operating. Here, as the actuator forming a part of the preventive mechanism, a stepping motor may be used instead of the solenoid. That is, the actuator is a mechanism that operates by supplying electric power.

A circuit forming at least a part of the control unit includes at least one of an analog circuit and a digital circuit. The analog circuit includes an analog element(s), and the digital circuit includes a digital element(s). A circuit(s) that forms at least a part of the control unit includes integrated circuits or a single integrated circuit chip.

Further, the preventive mechanism for preventing the reactive force being transmitted to the drive unit includes a mechanism for preventing an amount of operations of the contacting member, and a mechanism for blocking a power transmission route(s) between the contacting member and the drive unit, the reactive force being generated when the contacting member contacts with the workpiece.

Furthermore, a time to start the measurement of the elapsed time may be set to a point of time when the second mode is selected in addition to a point of time when the trigger switch is turned on.

As compressible gas, inert gas such as nitrogen gas or rare gas may be used instead of the compressed air. The striking part may have either a structure in which the piston and the driver blade are integrally molded or a structure of fixing the piston and the driver blade that are separated from each other. The fastener includes a nail that has a shaft part and a head part, as well as a fastener that has a shaft part and no head part. Operating the striking part in the direction of striking the fastener hardly has any relation with whether or not the striking part strikes the fastener.

10 . . . Driving tool; 11 . . . Housing; 13 . . . Striking part; 14 . . . Trigger; 16 . . . Push lever; 20 . . . Pressure accumulator chamber; 27 . . . Control chamber; 31 . . . Head valve; 33 . . . Port; 47 . . . Support shaft; 51 . . . Trigger valve; 73 . . . Fastener; 84 . . . Mode selection member; 87, 151, 153, 173, 179 . . . Solenoid; 100 . . . Control unit; 102 . . . Power supply circuit; 103 . . . Timer circuit; 134, 135 . . . Comparator; 138 . . . Capacitor; and 140A . . . Variable resistance.

1. A driving tool comprising:
a striking part provided so as to be operable and stoppable, the striking part operating by pressure of compressible gas to strike a fastener;
a housing supporting the striking part;
a pressure accumulator chamber provided in the housing and accommodating the compressible gas that is supplied from outside the housing;
a pressure chamber operating the striking part in a direction of operating the fastener when the compressible gas is supplied from the pressure accumulator chamber;
a route supplying the compressible gas in the pressure accumulator chamber to the pressure chamber;
an operating member provided in the housing, an operating force being applied to the operating member;
a contacting member provided in the housing and contacting with a workpiece that drives the fastener; and
a drive unit having a standby state for shutting off the route and an operating state for opening the route, the drive unit becoming the operating state when the contacting member contacts with the workpiece while the operating force is applied to the operating member,
wherein the drive unit has:
a first mode of changing the operating state from the standby state when the operating force is applied to the operating member while the contacting member contacts with the workpiece; and
a second mode of changing the operating state from the standby state when the contacting member contacts with the workpiece while the operating force is applied to the operating member,
a control unit detecting operations of the operating member and the contacting member is provided,
the control unit has a capacitor and is configured to start accumulating electric charges to the capacitor when the operating force is applied to the operating member in the second mode and to discharge the electric charges accumulated in the capacitor when the operating force applied to the operating member is released or when the contacting member contacts with the workpiece in the second mode, and
the control unit prevents the drive unit shifting to the operating state from the standby state based on the electric charges accumulated in the capacitor.

2. The driving tool according to claim 1,
wherein
the control unit has an active element that does not generate the output signal when a voltage of the capacitor is equal to or blow a predetermined voltage and that generates the output signal when the voltage of the capacitor exceeds the predetermined voltage.

3. The driving tool according to claim 2,
wherein the active element is a comparator.

4. The driving tool according to claim 1,
wherein the circuit has an analog circuit.

5. The driving tool according to claim 1,
wherein the circuit has a digital circuit.

6. The driving tool according to claim 1,
wherein the circuit includes an analog circuit and a digital circuit.

7. The driving tool according to claim 4,
wherein the circuit has a single integrated circuit.

8. The driving according to claim 3,
wherein a variable resistor is provided in a route in which the operating force is applied to the operating member to supply a current to the capacitor, and the predetermined time is variable by adjusting a resistance value.

9. The driving tool according to claim 8, further comprising:
a power supply control unit supplying the electric power to the control unit to start the control unit and stops supply of the electric power to the control unit to stop the control unit; and
a switching member operated by an operator and switching the first mode and the second mode to select one of the first and second modes,
wherein the power supply control unit supplies the electric power to the control unit to start the control unit when the second mode is selected.

10. The driving tool according to claim 9,
wherein the power supply control unit stops the supply of the electric power to the control unit to stop the control unit when the first mode is selected.

11. The driving tool according to claim 8, further comprising:
a mode changing mechanism switching the drive unit from the second mode to the first mode when the predetermined time elapses with the contacting member not contacting with the workpiece from a point from time when the operating force is applied to the operating member while the second mode is selected.

12. The driving tool according to claim 1, further comprising:
a preventive mechanism provided so as to be started by supplying electric power and receive the output signal generated based on the electric charges accumulated in the control unit to prevent a shift of the drive unit from the standby state to the operating state.

13. The driving tool according to claim 12,
wherein the preventive mechanism prevents reactive force being transmitted to the drive unit, the reactive force being generated when the contacting member contacts with the workpiece.

14. The driving tool according to claim 13,
wherein the drive unit includes:
a valve body opening and closing the route; and
a control chamber suppling and exhausting the compressible gas from the pressure accumulator chamber, the control chamber operating the valve body so as to close the route when the compressible gas is supplied, and operating the valve body so as to open the route when the compressible gas is discharged, and
the preventive mechanism prevents the drive unit discharging the compressible gas from the control chamber when the predetermined time lapses.

15. The driving tool according to claim 14,
wherein the preventive mechanism has a keep solenoid, the keep solenoid operating when the electric power is supplied, and stopping when the supply of the electric power is stopped, and
the control unit stops the supply of the electric power to the preventive mechanism at at least a part of time in a time interval taken until the elapsed time exceeds the predetermined time.

16. The driving tool according to claim 5,
wherein the circuit has a single integrated circuit.
